(19) United States
(12) Patent Application Publication
(10) Pub. No.: US 2025/0137620 A1
(43) Pub. Date: May 1, 2025

(54) CONDUIT LIGHT FIXTURE

(71) Applicant: LUMASCAPE PTY LTD, Eight Mile Plains (AU)

(72) Inventor: Glenn R. Lynch, Mansfield (AU)

(21) Appl. No.: 18/924,088

(22) Filed: Oct. 23, 2024

Related U.S. Application Data
(60) Provisional application No. 63/594,890, filed on Oct. 31, 2023.

(51) Int. Cl. F21V 17/12; F21S 8/02; F21V 15/01

(52) U.S. Cl. CPC F21V 17/12; F21S 8/022; F21V 15/01

(57) ABSTRACT

An in-grade light assembly can include an inner housing assembly. The inner housing assembly can include a body and a clamp configured to engage with the body so as to create an interference fit between the clamp and an outer structure.

### CROSS-REFERENCE TO RELATED APPLICATION

This application claims benefit under 35 U.S.C. 119 (e) to U.S. Provisional Patent App. No. 63/594,890, filed Oct. 31, 2023, the entire disclosure of which is hereby incorporated by reference herein in its entirety. Any and all priority claims identified in the Application Data Sheet, or any corrections thereto, are hereby incorporated by reference under 37 CFR 1.57.

### BACKGROUND

### Technical Field

The present invention relates to light fixtures, and more particularly, light fixtures designed for outdoor installation.

### Description of the Related Art

Outdoor lighting is popular for security, aesthetic, safety, and other reasons. Various types of commercial landscape light fixtures are available to meet the particular needs of residential or commercial properties. These include path, down, deck, tree, spot, spread, and security light fixtures.

### SUMMARY

In many installations and circumstances, it is desirable to utilize a light fixture that is reliable and easy to repair. This can be especially true in installation environments subject to rain or other environmental hazards. In some cases, a reliable and easy-to-repair light fixture can include an outer housing configured to receive an inner housing assembly. The inner housing assembly can be constructed to include many or most of the lighting and/or electrical components of the light fixture. In some cases, the inner housing assembly is interchangeable with other inner housing assemblies (e.g., replacement inner housing assemblies having varying lighting/power/operable features). The inner housing assembly can include structure configured to facilitate easy installation and removal of the body from the outer housing.

An aspect is directed to an in-grade light assembly for installation into a structure that has an inner surface, the in-grade light assembly comprises an inner housing assembly having a body and a clamp configured to slide relative to the body, the body having a member positioned to contact a first portion of the clamp as the clamp slides relative to the body so as to deflect a second portion of the clamp towards the inner surface, the second portion being configured to contact and create an interference fit with the inner surface of the structure.

Additional aspects further comprise wherein the interference fit is configured to inhibit movement of the in-grade light assembly relative to the structure.

Additional aspects further comprise wherein the member of the body is a corner or edge.

Additional aspects further comprise wherein the member is configured to deflect the second portion to move closer to or away from the inner surface.

Additional aspects further comprise wherein the member is fixed relative to the body.

Additional aspects further comprise wherein the first portion is a core or body of the clamp.

Additional aspects further comprise wherein the second portion is a tip of the clamp.

Additional aspects further comprise wherein the second portion comprises a contact surface, and wherein the interference fit is between the contact surface and the inner surface.

Additional aspects further comprise wherein when the clamp slides relative to the body, the second portion is configured to move closer to or away from the inner surface of the structure.

Additional aspects further comprise wherein when the clamp slides relative to the body, an effective cross sectional size of the body changes.

Additional aspects further comprise a lens assembly connected to the body.

Additional aspects further comprise wherein a driving screw configured to cause the clamp to slide relative to the body.

Additional aspects further comprise wherein rotation of the driving screw causes the clamp to slide relative to the body.

Additional aspects further comprise wherein a nut, the nut being coupled to the clamp and configured to be driven by the drive screw.

Additional aspects further comprise wherein a cover configured to be secured to the body by the driving screw.

Additional aspects further comprise the structure, the structure having a first end configured to be positioned at or below a ground level or wall surface when installed, a second end opposite the first end, and a sleeve portion between the first end and the second end, the sleeve portion having the inner surface.

Additional aspects further comprise wherein the clamp is configured to move toward and away from the first end of the structure in response to user input to the driving screw when the inner housing assembly is installed within the structure.

An aspect is directed to a method of assembling an in-grade light assembly. The method comprises inserting an inner housing assembly into an open end of an outer structure having an outer structure axis, the inner housing assembly comprising a body and a clamp and sliding the clamp along the body in a direction parallel to the outer structure axis so as to create an interference fit between the clamp and the outer structure.

Additional aspects further comprise wherein sliding the clamp along the body is caused by rotating one or more driving screws.

Additional aspects further comprise wherein the clamp comprises a tip, and wherein the interference fit is created between the tip and the outer structure.

Additional aspects further comprise wherein rotating the one or more driving screws further secures a cover to the inner housing assembly.

An aspect is directed to an in-grade light assembly for installation into a structure that has an inner surface. The in-grade light assembly comprises a body and a clamp configured to slide along the body so as to create an interference fit between the clamp and the inner surface of the structure.

Additional aspects further comprise wherein the clamp comprises a tip, and wherein when the clamp slides along the body the tip moves closer to or away from the inner surface of the structure.

Additional aspects further comprise wherein the structure is a PVC pipe, a conduit, a cored-out hole, a cored-out hole in a paver or concrete, or a hole in wood a PVC pipe.

### BRIEF DESCRIPTION OF THE DRAWINGS

The present disclosure is described with reference to the accompanying drawings, in which like reference characters reference like elements, and wherein:

FIG. 1 is a perspective side view of an in-grade light after being placed into a preexisting conduit but prior to securing the in-grade light to the conduit.

FIG. 2 is a cross-section view through the in-grade light of FIG. 1 showing a clamp of the in-grade light disengaged from an inner surface of the conduit.

FIG. 3 is a perspective side view similar to FIG. 1 except drive screws of the in-grade light fixture have been rotated to retract the clamp causing a tip of the clamp to move in an outward direction towards the inner surface of the conduit.

FIG. 4 is a cross-section view through the in-grade light of FIG. 3 showing that the tip of the clamp has moved closer (X′ length) to the inner surface of the conduit than in FIG. 2 (X length).

FIG. 5 is a perspective side view similar to FIG. 3 except the drive screws of the in-grade light fixture have been further rotated to further retract the clamp causing the tip of the clamp to bite into the inner surface of the conduit securing the in-grade light fixture.

FIG. 6 is a cross-section view through the in-grade light of FIG. 5 showing the tip of the clamp has bit into the inner surface of the conduit (X″ length).

### DETAILED DESCRIPTION

Outdoor light fixtures are often exposed to environmental hazards such as moisture, temperature variants, dirt, wind, sunlight, and other hazards. Additionally, like many electrical devices, light fixtures often require routine and non-routine maintenance for a variety of reasons. For example, light engines, light bulbs, circuits, wiring, and other components of light fixtures may have limited service lives and may require replacement and/or repair. In some cases, one or more components of the light fixture may be consumable, while all or most of the remaining components are designed for long-term installation and use.

Repair and replacement of components in a light fixture, especially an outdoor light fixture can be costly, as the maintenance services can require specially-trained technicians and may require complete or substantially complete replacement of the entire fixture. As such, it is desirable that the repair of light fixtures be simplified to both reduce the cost of repair and to expedite the process of repairing the light fixtures.

In-ground lights are sometimes referred to as “in-grade lights”. In-Grade lights can provide desired lighting for applications such as landscaping, structural lighting, pathway lighting, or other applications where upward-directed light is desired. In-Grade lights can also be used in applications to provide downward-directed or sideways-directed light. In-Grade lights can be installed in many environments including, but not limited to, landscaping beds, concrete (e.g., walkways or driveways), and/or turf. In-Grade lights can have a low profile (e.g., extend very little or not at all in an upward direction from the ground). In-Grade lights can be flush with or (entirely or partially) recessed from an adjacent surface. In some applications, activities such as lawn mowing, walking, driving, pressure-washing, and/or other activities can be performed on and/or near in-grade lights without negatively impacting the integrity or performance of the light fixture.

Embodiments of in-grade light fixtures 100 discussed herein provide structures which simplify installation and repair by, for example, employing an adjustable clamp 112. For example, the in-grade light fixture 100 can be placed in a conduit or outer housing 102. The conduit or housing 102 can be fixedly installed almost entirely below ground level. In certain embodiments, the in-grade light fixture 100 need not be installed into the conduit 102 and instead can be installed into another structure that has a cylindrical inner shape. For example, in certain embodiments, the in-grade light fixture 100 can be installed into a PVC pipe, a cored-out hole in a paver or concrete, a hole in wood, etc.

An example of such an in-grade light 100 is illustrated in the figures. The in-grade light 100 can include one or more housings in which electrical and mechanical components are housed. For example, the in-grade light 100 can include the conduit 102. An inner housing assembly 105 of the in-grade light 100 may be positioned at least partially within the conduit 102 when the in-grade light 100 is assembled.

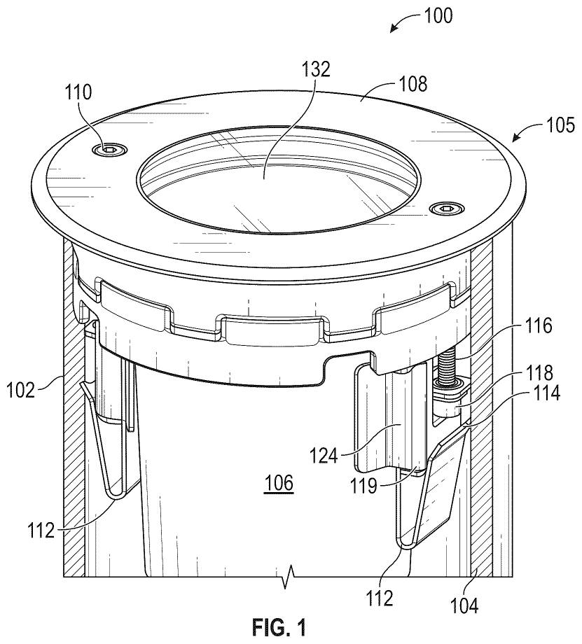

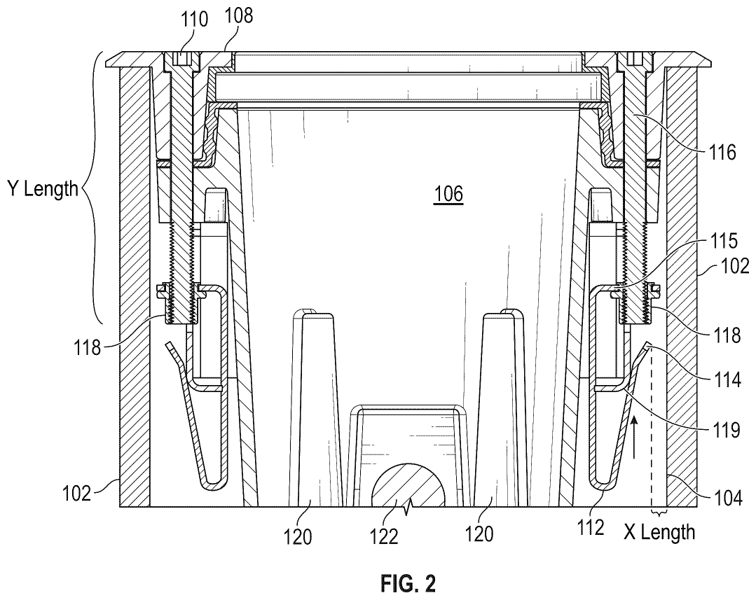

FIG. 1 is a perspective side view of an in-grade light 100 after being placed into a preexisting conduit 102 but prior to securing the in-grade light 100 to the conduit 102. FIG. 2 is a cross-section view through the in-grade light 100 of FIG. 1 showing the clamp 112 of the in-grade light 100 disengaged from an inner surface 104 of the conduit 102. The light components which are part of the inner housing assembly 105 are installed within the conduit 102. In certain embodiments, the light components are disposed in a body 106 of the inner housing assembly 105.

In certain embodiments, the inner housing assembly 105 comprises the clamp 112. In certain embodiments, the clamp 112 slidingly engages the body 106 of the inner housing assembly 105. For example, in certain embodiments, the clamp 112 of the inner housing assembly 105 slides in a longitudinal (up/down) direction relative to the body 106 causing a tip 114 of the body of the clamp 112 to engage with the inner surface 104 of the conduit 102.

In certain embodiments, rotation of one or more drive screws 116 causes the clamp 112 to slide relative to the body 106. Depending on whether the one or more drive screws 116 are rotated in a clockwise or counterclockwise direction, the clamp 112 moves in an upward or downward direction relative to the body 106. In certain embodiments, the user employs a tool (e.g., screw drive) to rotate the one or more drive screws 116 via a tool engagement end 110. By rotating the one or more drive screws 116, the user is able to secure the inner housing assembly 105 in the conduit 102 by creating a desirable amount of interference fit between the tip 114 of the clamp 112 and the conduit 102. For example, the interference fit can lock the inner housing assembly 105 in the conduit 102. In certain embodiments, the tip 114 of the clamp 112 contacts the conduit 102. In certain embodiments, the tip 114 contacts the inner surface 104 of the conduit 102. In other embodiments, a different portion of the clamp 112 contacts the conduit 102. For example, depending on an outer profile of the clamp 112, the portion of the clamp 112 contacting the inner surface 104 need not be the tip 114 and instead could be any other portion of the clamp 112 (e.g., bend, barb, arm, teeth, protrusion, etc.).

In certain embodiments, the inner housing assembly 105 can have one clamp 112 and/or one tip 114 on the clamp 112. In certain other embodiments, the inner housing assembly 105 can include a plurality of clamps 112 and/or a plurality of tips 114 on each clamp 112. For example, in certain embodiments, the inner housing assembly 105 comprises two clamps 112 disposed about a circumference of the body 106. In certain embodiments, the two clamps 112 can be spaced 180 degrees apart about the circumference of the body 106. In certain embodiments, the inner housing assembly 105 comprises three clamps 112 disposed about the circumference of the body 106. In certain embodiments, the three clamps 112 can be spaced 120 degrees apart about the circumference of the body 106. Thus, the inner housing assembly 105 is not limited to having the illustrated number of clamps 112 and can instead have any number of clamps 112 (e.g., 1, 3, 4, 5, 6, 7, 8, 9, 10, 11, 12, etc.) with any spacing without deviating from the scope of this disclosure.

In certain embodiments, the inner housing assembly 105 comprises a nut 118. In certain embodiments, the nut 118 is coupled to the clamp 112 and configured to move along the drive screw 116. In certain embodiments, a proximal end 115 of the clamp 112 is coupled to the nut 118. For example, rotation of the drive screw 116 causes the nut 118 and the clamp 112, via the proximal end 115, to move in an upward or downward direction depending on the direction the drive screw 116 is rotated. The relative rotation of the engaged threads on the nut 118 and the drive screw 116 causes the nut 118 to move along the length of the drive screw 116. Movement of the nut 118 moves the tip 114 via movement of the proximal end 115 of the clamp 112. In this way, in certain embodiments, the tool engagement end 110 of the drive screw 116 can remain flush with a top of the light fixture 100 regardless of the position of the nut 118 along the drive screw 116.

In certain embodiments, the inner housing assembly 105 further comprises a surface 119. In certain embodiments, the surface 119 is configured to deflect the tip 114 of the body of the clamp 112 towards the inner surface 104. In certain embodiments, the surface 119 is disposed on member 124. In certain embodiments, the surface 119 is a corner or edge of the member 124. In the illustrated embodiment, the surface 119 is a bottom edge or corner of the member 124.

In certain embodiments, as the nut 118 and the clamp 112 move in an upward direction the surface 119 deflects the tip 114 of the clamp 112 towards the inner surface 104. This deflection leads to interference between the clamp 112 and the inner surface 104 which can inhibit or prevent movement of the body 106 within the conduit 102. In some embodiments, the inner surface 104 can include one or more surface features (e.g., grooves, protrusions, etc.) configured to increase a degree of the interference between the clamp 112 and the inner surface 104 of the conduit 102.

In the illustrated embodiment, at least a portion of the clamp 112 has a U shape. Of course the shape of the clamp 112 is not limited to the illustrated shape and can have any other shape. For example, in certain embodiments, the portion of the clamp 112 has a V shape or T shape.

The clamp 112 can be manufactured out of one or more materials (e.g., plastic, rubber, metal, etc.). The one or more materials can be selected to provide an adequate level of friction (e.g., prevent relative movement once installed) when in contact with the cylindrical shaped structure. For example, the clamp 112 can be made from metal or another high hardness material if the contact between the metal and the material of the cylindrical shaped outer structure provides an adequate level of friction to prevent relative movement (e.g., metal and a very rough concrete or rock material). The amount of friction can be further adjusted by varying the size of the contact area between the tip 114 of the clamp 112 and the cylindrical shaped structure and/or the number of the clamps 112.

In certain embodiments, the body of the clamp 112 is made from more than one material. For example, in certain embodiments, a core or body of the clamp 112 is manufactured out of metal and the regions (e.g., tips 114) of the clamp 112 which contact the cylindrical shaped structure are manufactured from silicone or other high friction material to enhance their grip with the cylindrical shaped structure. In certain embodiments, the tip 114 is over molded with the core or body of the clamp 112. In certain other embodiments, the tips 114 are assembled to the clamp 112.

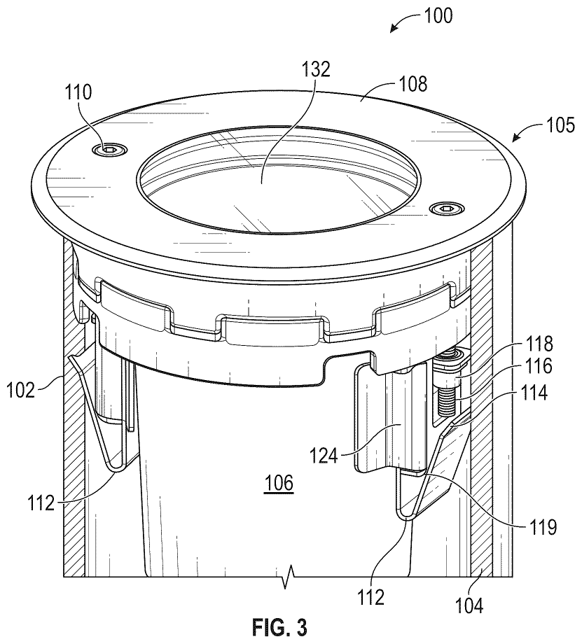

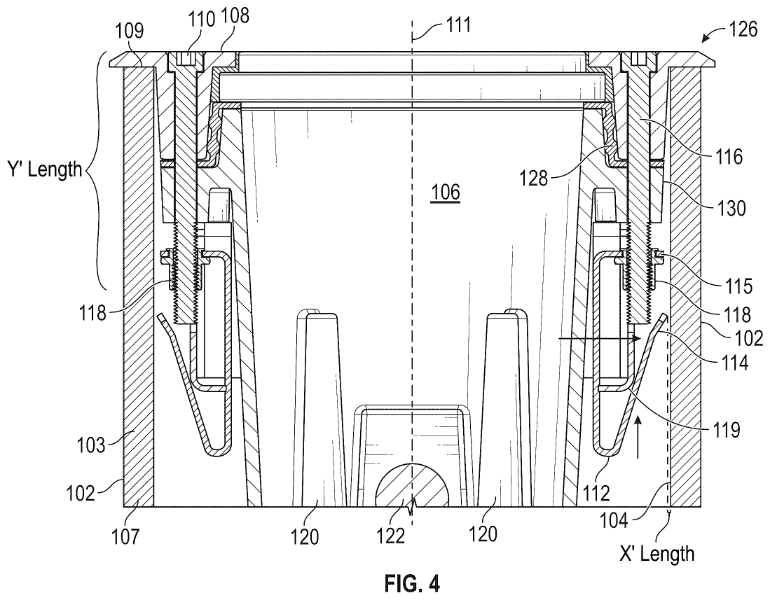

FIG. 3 is a perspective side view similar to FIG. 1 except the drive screws 116 of the in-grade light 100 have been rotated to retract the clamp 112 in an upward direction causing the tip 114 of the clamp 112 to move in an outward direction towards the inner surface 104 of the conduit 102. FIG. 4 is a cross-section view through the in-grade light 100 of FIG. 3 showing that the tip 114 of the clamp 112 has moved closer (X′ length) to the inner surface 104 of the conduit 102 than in FIG. 2 (X length). The nut 118 has also moved closer (Y′ length) to the tool engagement end 110 of the drive screw 116 than in FIG. 2 (Y length).

Because in-grade lights 100 are often installed at least partially underground, they are especially susceptible to moisture, dirt, and other environmental hazards. In some cases, the position of the in-grade light 100 can make replacement and/or repair of parts within the light difficult due to the high risk of moisture ingress into the light and the difficulty of removing moisture from the light. Additionally, it can be difficult to secure the in-grade light 100 within the conduit 102.

The inner housing assembly 105 can include the body 106 and a light module or cartridge disposed within the body 106. In some embodiments, the body 106 can be configured to releasably connect to the conduit or outer housing 102 via the clamp 112. For example, in the illustrated embodiment, adjustment of the clamp 112 relative to the body 106 can fix and/or lock a position of the inner housing assembly 105 within the conduit or outer housing 102. In certain embodiments, the light module or cartridge can be tilted relative to the body 106.

The in-grade light 100 can include a cover 108 configured to couple with one or both of the conduit 102 and the inner housing assembly 105. In certain embodiments, the cover 108 has a circular outer shape. A circular inner shape of the cover 108 can be configured to interface with an outer circumference of a lens 132. The lens 132 can be installed on the body 106 to seal an interior of the inner housing assembly 105. For example, the lens 132 can be compressed between a top surface of the body 106 and the cover 108 by turning the one or more driving screws 116.

The body 106 can be manufactured out of one or more materials (e.g., plastic, rubber, metal, etc.). For example, in certain embodiments, the body 106 can be made from brass. In other embodiments, the body 106 is made from a composite plastic.

In certain embodiments, the body 106 comprises one or more supports 120, 122. The one or more supports 120, 122 can be configured to provide additional strength to the body 106. In the illustrated embodiment, a top portion of the one or more supports 120, 122 have a conical frustum shape. In the illustrated embodiment, the one or more supports 120, 122 are disposed on an inner surface of the body 106 and aligned in a vertical or up/down direction. In certain embodiments, the one or more supports 120, 122 provide a support or contact surface for the light module or cartridge disposed within the body 106.

As will be discussed in more detail below, the in-grade light 100 can include one or more mechanisms or structures configured to facilitate fixing and/or locking the position of the inner housing assembly 105 within the conduit or outer housing 102.

The conduit 102 of the in-grade light 100 can include a sleeve portion 103. The sleeve portion 103 can have a first end (e.g., lower end) 107 and a second end (e.g., upper end) 109. The second end 109 can be open. In some embodiments, the first end 107 is closed. In the illustrated embodiment, the conduit 102 (e.g., the sleeve portion 103) is hollow or at least partially hollow. The conduit or outer housing 102 can have an outer housing axis 111 extending through one or both of the first and second ends 107, 109 of the sleeve portion 103.

As illustrated in FIG. 4, the sleeve portion 103 can be connected to a connection portion 126. The connection portion 126 can be, for example, positioned at the second end 109 of the sleeve portion 103. The connection portion 126 can be configured to connect and/or support the inner housing assembly 105 and/or the cover 108. In certain embodiments, the connection portion 126 can comprise a gasket or seal 128. In certain embodiments, the gasket or seal 128 is at least partially disposed between outer upper surfaces of the body 106 and the cover 108. In certain embodiments, a portion of the gasket or seal 128 is disposed between the lens 132 and a top surface of the body 106. In certain embodiments, the gasket or seal 128 has a general Z shape which extends between the top surface of the body 106 and the one or more driving screws 116. In certain embodiments, the gasket or seal 132 comprises one or more openings for the one or more driving screws 116 to pass therethrough.

The sleeve portion 103 can have a cylindrical or generally cylindrical shape. In some embodiments, one or more segments of the sleeve portion 103 have a different shape from one or more other segments of the sleeve portion 103. For example, one or more segments of the sleeve portion 103 can have a rectangular cross-sectional shape (e.g., as measured perpendicular to the outer housing axis 111), a triangular cross-sectional shape, an oval cross-section, and/or some other polygonal or curved cross-sectional shape.

In certain embodiments, the conduit 102 can include one or more electrical ports. In certain embodiments, the conduit 102 can include two electrical ports. Three or more electrical ports are also contemplated.

The one or more electrical ports can be configured to facilitate electrical connection between the interior of the conduit 102 and the exterior of the conduit 102. In certain embodiments, the one or more electrical ports can be positioned at or near the first end 107 of the sleeve portion 103. In certain embodiments, the one or more electrical ports can be positioned at or near the second end 109 of the sleeve portion 103.

In certain embodiments, one or more of the electrical ports can be a stamped portion of the sleeve portion 102. The stamped portion can be punched out if or when the user (e.g., installation technician) decides to use the electrical port in question. Unused electrical ports can be left un-punched and impervious to fluid ingress or egress. The electrical ports may be molded into the conduit 102 for example when the conduit 102 is a plastic material.

The electrical ports can include threaded portions configured to engage with electrical fittings. In some embodiments, the electrical ports are configured to engage with external electrical fittings in a fluid and/or liquid-tight manner.

The inner housing assembly 105 can be configured to couple and decouple with the conduit 102. In some embodiments, the inner housing assembly 105 is configured to pass at least partially through the second end 109 of the conduit 102 during coupling with and decoupling from the conduit 102.

The inner housing assembly 105 can be constructed such that, when assembled, the inner housing assembly 105 hermetically (e.g., in an air-tight, or water-tight manner) seals an interior of the inner housing assembly 105 from an exterior of the inner housing assembly 105. For example, the hermetic seal can be achieved when the cover 108 compresses the seal or gasket 128 between the lens 132 and the top surface of the body 106.

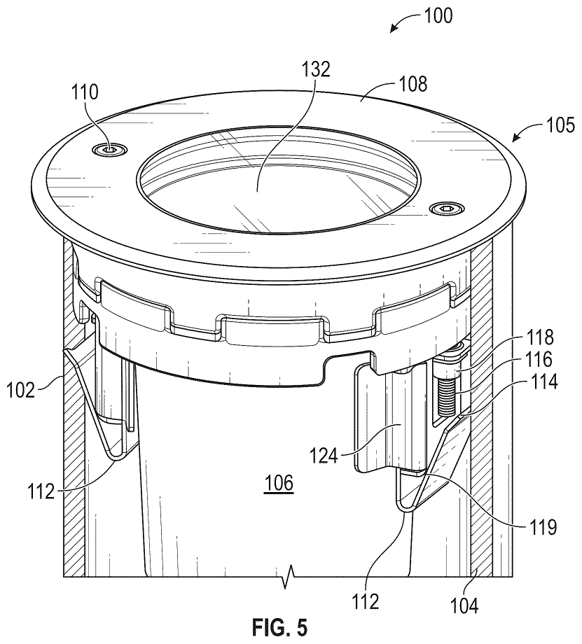

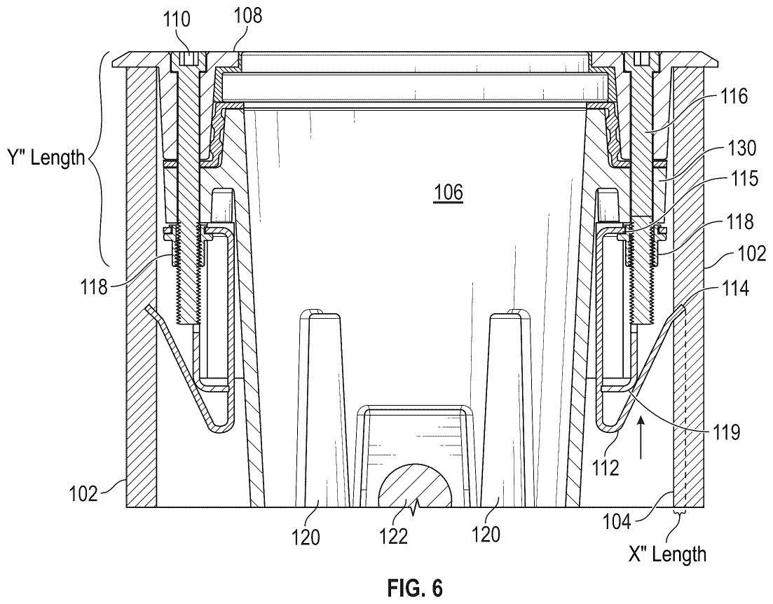

FIG. 5 is a perspective side view similar to FIG. 3 except the drive screws 116 of the in-grade light 100 have been further rotated to further retract the clamp 112 causing the tip 114 of the clamp 112 to bite into the inner surface 104 of the conduit 102 securing the in-grade light 100. FIG. 6 is a cross-section view through the in-grade light 100 of FIG. 5 showing the tip 114 of the clamp 112 has bit into the inner surface 104 of the conduit 102 (X″ length). The nut 118 has also moved closer (Y″ length) to the tool engagement end 110 of the drive screw 116 than in FIG. 4 (Y′ length).

The inner housing assembly 105 (e.g., body 106) can include a mating structure 130. The mating structure 130 can be, for example, a shoulder, flange, indentation, protrusion, aperture, and/or some other structure configured to facilitate mating between the inner housing assembly 105 and the conduit or outer housing 102. In the illustrated embodiment, the mating structure 130 is a shoulder configured to be held (e.g., compresses, wedged, and/or secured) between the head of the driving screw 116 and the nut 118 when the nut 118 and the clamp 112 are moved in the upward direction. In some embodiments, one or more intermediate structures such as the seal 128 and/or cover 108 can be positioned between the head of the driving screw 116 and the nut 118 to hold the mating structure 130. In this way, rotation of the driving screw 116 can cause the nut 118 to tighten the mating structure 130 while also causing the tip 114 of the clamp 112 to bite into the inner surface 104 of the conduit 102 securing the in-grade light 100. In certain embodiments, the nut 118 is snug against the mating structure 130 in FIG. 4 to also secure the cover 108. In certain embodiments, the nut 118 need not be snug against the mating structure 130 when the inner housing assembly 105 is secured in the conduit 102.

In certain embodiments, the body 106 is hollow or at least partially hollow and is configured to receive the light module or cartridge. The light module or cartridge can be configured to removably connect to the body 106. The light module or cartridge can include numerous structural features and components configured to house, maintain, or otherwise integrate with one or more electrical/lighting features and components. The light module or cartridge can be configured to facilitate removal, repair, installation, and/or other customization of the lighting features connected to the light module or cartridge.

The electrical/lighting components can include a light unit assembly. The light unit assembly can be configured to generate light and direct that light with desired lighting characteristics (e.g., shape, intensity, direction, color, and/or other characteristics) from the light module or cartridge. In some embodiments, the light module or cartridge includes one or more electrical connections (e.g., plugs) configured to electronically connect with complementary electronic features of the in-grade light 100.

The light unit assembly can include a light engine configured to generate light. In some embodiments, the light unit assembly includes a beam reflector and/or a beam director, each of which can be configured to alter the shape and/or intensity of the light generated by the light engine. The light engine can be or include a light emitting diode (LED) or an array of multiple LED's. In some embodiments, the light engine is a light bulb (e.g., an incandescent, fluorescent, halogen, or other bulb type). In some embodiments, the light engine includes one or more circuit boards and/or other electrical components. The light engine can be electronically connected to one or more sources of power and/or to one or more control units. For example, the light engine can include a plug or other electrical connector configured to mate with the driver and/or with some other component of the light module or cartridge. The light unit assembly can include one or more optical components. The optical component(s) can be, for example, one or more of a diffuser, a color filter, secondary lens, and/or some other optical component.

In some embodiments, the light module or cartridge can be tilted or otherwise non-parallel to the body 106. Angular offset between the light module or cartridge and the body 106 can permit direction of the light from the light module or cartridge in a direction tilted from the fixture housing axis 111.

One or more of the structural features of the clamp 112 can be configured to releasably mate with one or more features of the conduit 102 to facilitate quick and easy installation and removal of the inner housing assembly 105 to and from the conduit 102. In certain embodiments, the inner housing assembly 105 can be configured to expand an effective outer diameter of the body 106. In certain embodiments, this expansion occurs when the clamp 112 slides in an upward direction relative the body 106. In certain embodiments, as the clamp 122 slides in the upward direction relative the body 106 an interference fit is created between the tip 114 of the clamp 112 and the inner surface 104 of the conduit or outer housing 102. In certain other embodiments, the clamp 112 of the inner housing assembly 105 can be configured to effectively expand the outer diameter of the body 106 as the nut 118 and the clamp 112 slide in a downward direction relative the body 106 to create the interference fit between the outer diameter of the body 106 and the inner surface 104 of the conduit or outer housing 102. Accordingly, the disclosure is not limited to the illustrated embodiment.

In certain embodiments, as the one or more driving screws 116 are tightened, the corresponding nuts 118 raise their clamps 112 causing the surface 119 to deflect the tips 114 of the clamps 112 in an outward direction towards the inner surface 104 of the conduit or outer housing 102. As further tightening occurs, the amount of deflection increases until an interference fit or pressure between the clamps 112 and the inner surface 104 of the conduit outer housing 102 essentially locks or fixes the position of the inner housing assembly 105 within the conduit or outer housing 102.

In certain embodiments, the tip 114 includes one or more contact surfaces which form the interference fit with the inner surface 104 of the conduit or outer housing 102. In certain embodiments, the one or more contact surfaces are made of a material that provides an adequate level of friction or grip with the inner surface 104 of the conduit or outer housing 102. In certain embodiments, the one or more contact surfaces have a surface roughness selected to enhance the interference fit or grip with the inner surface 104 of the conduit or outer housing 102.

In certain embodiments, loosening of the one or more drive screws 116 allows the tip 114 of the clamp 112 to flex back in a direction away from the inner surface 104 of the conduit 102 as the nut 118 moves in a downward direction along the shaft of the drive screw 116. Once sufficiently loosened, the interference fit is removed or lowered so as to allow the inner housing assembly 105 to be lifted out of the conduit 102 for replacement or service. The inner housing assembly 105 may also be rotated within the conduit 102 for adjustment of the angle of the light beam without lifting the inner housing assembly 105 out of the outer housing 102. Of course, the nut 118 and the clamp 112 could either move in the upward or downward directions and still fall within the scope of this disclosure. In some cases, all or a portion of the inner housing assembly 105 can be disassembled while positioned in the conduit or outer housing 102.

The lens 132 can be installed on the body 106 to seal an interior of the inner housing assembly 105. For example, the lens 132 can be installed on the inner housing assembly 105 using the driving screw 116.

To remove the inner housing assembly 105 from the conduit or outer housing 102, the user may loosen the one or more driving screws 116 to diminish or remove the interference fit or pressure sufficiently to allow the user to lift the inner housing assembly 105 from the conduit or outer housing 102. In some embodiments, one or more electrical connections (e.g., plugs or other connections) between the inner housing assembly 105 and some other portion of the in-grade light 100 can be disconnected to completely remove the inner housing assembly 105 from the in-grade light 100.

For expository purposes, the term “horizontal” as used herein is defined as a plane parallel to the plane or surface of the floor of the area in which the system being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

The terms “approximately”, “about”, “generally” and “substantially” as used herein represent an amount close to the stated amount that still performs a desired function or achieves a desired result. For example, the terms “approximately”, “about”, “generally,” and “substantially” may refer to an amount that is within less than 10% of the stated amount.

What is claimed is:

1. An in-grade light assembly for installation into a structure that has an inner surface, the in-grade light assembly comprising:
an inner housing assembly having a body and a clamp configured to slide relative to the body, the body having a member positioned to contact a first portion of the clamp as the clamp slides relative to the body so as to deflect a second portion of the clamp towards the inner surface, the second portion being configured to contact and create an interference fit with the inner surface of the structure.

2. The in-grade light assembly of claim 1, wherein the interference fit is configured to inhibit movement of the in-grade light assembly relative to the structure.

3. The in-grade light assembly of claim 1, wherein the member of the body is a corner or edge.

4. The in-grade light assembly of claim 1, wherein the member is configured to deflect the second portion to move closer to or away from the inner surface.

5. The in-grade light assembly of claim 1, wherein the member is fixed relative to the body.

6. The in-grade light assembly of claim 1, wherein the first portion is a core or body of the clamp.

7. The in-grade light assembly of claim 1, wherein the second portion is a tip of the clamp.

8. The in-grade light assembly of claim 1, wherein the second portion comprises a contact surface, and wherein the interference fit is between the contact surface and the inner surface.

9. The in-grade light assembly of claim 1, wherein when the clamp slides relative to the body, the second portion is configured to move closer to or away from the inner surface of the structure.

10. The in-grade light assembly of claim 1, wherein when the clamp slides relative to the body, an effective cross sectional size of the body changes.

11. The in-grade light assembly of claim 1, further comprising a lens assembly connected to the body.

12. The in-grade light assembly of claim 1, further comprising a driving screw configured to cause the clamp to slide relative to the body.

13. The in-grade light assembly of claim 12, wherein rotation of the driving screw causes the clamp to slide relative to the body.

14. The in-grade light assembly of claim 12, further comprising a nut, the nut being coupled to the clamp and configured to be driven by the drive screw.

15. The in-grade light assembly of claim 12, further comprising a cover configured to be secured to the body by the driving screw.

16. The in-grade light assembly of claim 12, further comprising the structure, the structure having:
a first end configured to be positioned at or below a ground level or wall surface when installed;
a second end opposite the first end; and
a sleeve portion between the first end and the second end, the sleeve portion having the inner surface.

17. The in-grade light assembly of claim 16, wherein the clamp is configured to move toward and away from the first end of the structure in response to user input to the driving screw when the inner housing assembly is installed within the structure.

18. A method of assembling an in-grade light assembly, the method comprising:
inserting an inner housing assembly into an open end of an outer structure having an outer structure axis, the inner housing assembly comprising a body and a clamp; and
sliding the clamp along the body in a direction parallel to the outer structure axis so as to create an interference fit between the clamp and the outer structure.

19. The method of claim 18, wherein sliding the clamp along the body is caused by rotating one or more driving screws.

20. The method of claim 18, wherein the clamp comprises a tip, and wherein the interference fit is created between the tip and the outer structure.

21. The method of claim 18, wherein rotating the one or more driving screws further secures a cover to the inner housing assembly.

22. An in-grade light assembly for installation into a structure that has an inner surface, comprising:
a body; and
a clamp configured to slide along the body so as to create an interference fit between the clamp and the inner surface of the structure.

23. The in-grade light assembly of claim 22, wherein the clamp comprises a tip, and wherein when the clamp slides along the body the tip moves closer to or away from the inner surface of the structure.

24. The in-grade light assembly of claim 22, wherein the structure is a PVC pipe, a conduit, a cored-out hole, a cored-out hole in a paver or concrete, or a hole in wood.
